(19) United States
(12) Patent Application Publication
(10) Pub. No.: US 2007/0195677 A1
(43) Pub. Date: Aug. 23, 2007

(54) OPTICAL PICKUP, OPTICAL DISK DRIVE HAVING THE SAME, AND METHOD OF BONDING OPTICAL COMPONENT TO THE SUBSTRATE THEREOF

(75) Inventor: Takahiro Yamamoto, Fuchu-City (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Samsung Storage Technology Corporation, Kawasaki-City (JP)

(21) Appl. No.: 11/672,752

(22) Filed: Feb. 8, 2007

(30) Foreign Application Priority Data
Feb. 23, 2006 (JP) 2006-046931

(51) Int. Cl. G11B 7/00

(52) U.S. Cl. 369/112.28

(57) ABSTRACT

The substrate of a housing that holds a prism optical component has almost hemispherical recesses at positions that correspond to the four corners of the prism optical component. An adhesive that is fast dried is applied into the hemispherical recesses. To the back of the prism optical component, an adhesive that is cured with time or a thermosetting adhesive is applied, forming a thin layer having uniform thickness.

### CROSS-REFERENCE TO RELATED APPLICATIONS

This application is based upon and claims the benefit of priority from the prior Japanese Patent Application No. 2006-46931, filed on Feb. 23, 2006, the entire content of which are incorporated herein by reference.

### BACKGROUND OF THE INVENTION

1. Field of the Invention

The present invention relates to an optical pickup in which an optical component, such as a prism optical component, is bonded to the substrate in a specific manner, to an optical disk drive having the optical pickup, and to a method of bonding the optical components to the substrate.

2. Description of the Related Art

In order to secure an optical component, such as a prism, to a substrate at high precision and with high reliability, it is necessary to adjust the position of the component at sufficient precision, to use an adhesive that excels in reliability and to apply the adhesive uniformly.

Several proposals have hitherto been made as to how optical components should be bonded. For example, there is an optical element in which two or more optical members different in thickness are bonded together. In this optical element, grooves are made in the junction part of the thinner optical member or in a part thereof, which lies near the junction part. (See, for example, Jpn. Pat. Appln. Laid-Open Publication No. 2000-56199.) There is another optical element in which a first optical element (second polarizer 16) and a second optical element (Faraday rotor 15) are bonded with an adhesive, forming an integral unit. In this optical element, a groove or a projection of a predetermined width and a predetermined depth or height is made in or on the major surface of a second polarizer 16 at the position where a Faraday rotor 15 is bonded, and extends along the outer periphery of the Faraday rotor 15. (See, for example, Jpn. Pat. Appln. Laid-Open Publication No. 2003-255207.)

Hitherto, a considerably long time passes until an adhesive solidifies in the process of bonding and securing optical components to a substrate. Thermosetting epoxy resin, for example, is an adhesive of high reliability. However, when it is used to bond a component, the component must be first adjusted in angle at minute-order precision and positioned at micron-order precision and be then held until the resin is completely cured. This process is disadvantageous, however. In practice, thermosetting epoxy resin cannot be used. UV-curable resin is used instead.

If UV-curable resin is used, the component cannot maintain its shape as the temperature changes. Annealing must therefore be performed on the actual device to achieve tuning.

### BRIEF SUMMARY OF THE INVENTION

It is an object of the present invention to provide an optical pickup in which optical components are bonded and secured with high reliability, while positioned at high precision.

In an aspect of the present invention, there is provided an optical pickup that comprises a substrate and a prism optical component fixed, with a first adhesive, at a predetermined position on the substrate. The substrate has a plurality of almost hemispherical recesses in a surface of the substrate, at positions corresponding to four corners of the prism optical component, and a second adhesive has been applied into the recesses.

### BRIEF DESCRIPTION OF THE DRAWINGS

FIG. 1 is a plan view of an optical pickup incorporated in an optical disk drive according to the present invention;

FIG. 2 is a perspective view showing the positional relation between a prism optical component and a housing substrate;

FIG. 3 is a partially sectional view explaining how the prism optical component is bonded to the housing substrate; and

FIG. 4 is a partially sectional view explaining how the prism optical component is bonded to the housing substrate.

### DETAILED DESCRIPTION OF THE INVENTION

An embodiment of the present invention will be described with reference to the accompanying drawings. The component identical to those shown in other drawings are designated at the same reference numbers and will not be described repeatedly.

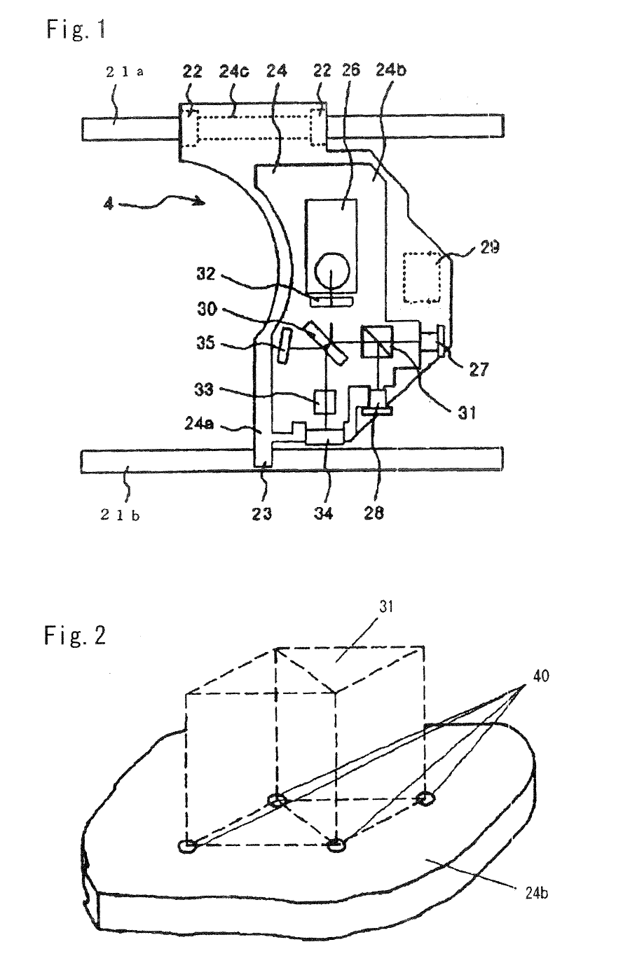

FIG. 1 is a plan view of the optical pickup head provided in an optical disk drive according to this invention. The optical pickup head 4 comprises a pick housing (also called housing, hereinafter) 24 that contains various components required for reproducing and recording data. The pickup housing 24 is made of metal excelling in thermal conductivity, such as aluminum, magnesium or zinc. It is shaped like a trapezoidal box as viewed from above and has a sidewall 24a and a bottom wall 24b (hereinafter referred to as substrate).

The sidewall 24a has a through hole 24c at one end. A main-axis guide bar 21a extends through the hole 24c. Two sliding bearings 22 are fitted at the both ends of the hole 24c, respectively. At the other end of the sidewall 24a, a bearing 23 is integrally formed with the sidewall 24a and projects from the sidewall 24a. A main-axis guide bar 21a and a sub-axis guide bar 21b extend from the left to the right, at the sides of the pickup housing 24, respectively. The main-axis guide bar 21a supports the bearings 22 and the sub-axis guide bar 21b supports the bearing 23. The pickup housing 24 can therefore move in the radial direction of a disk (not shown) (i.e., to the left to the right, and vice versa, as seen in FIG. 1). Thus, the pickup housing 24 can freely slide, guided by the guide bars 21a and 21b.

Two detecting systems are provided in the pickup housing 24, one for CDs, and the other for DVDs. The pickup housing 24 incorporates a laser diode 27, a laser diode 28, a prism 31, a mirror 30, a collimator lens 32, a photodetector 34, a drive circuit board 29, and an objective-driving device 26. The laser diode 27 (wavelength: 780 nm) is the light source for reading data from CDs. The laser diode 28 (wavelength: 650 nm) is the light source for reading data from DVDs. The prism 31 is provided to guide the light beams from these diodes 27 and 28 to the disk. The photodetector 34 works for CDs and DVDs and detects reflected light from the disk The drive circuit board 29 is provided to drive the laser diode 27 for reading data from CDs. The objective-driving device 26 comprises some components and an objective lens. The components include a circuit for driving the laser diode 28 for DVDs, a high-frequency module, and a front monitor 35. The objective lens is used to position, at high precision, a light beam spot at a predetermined position on the disk.

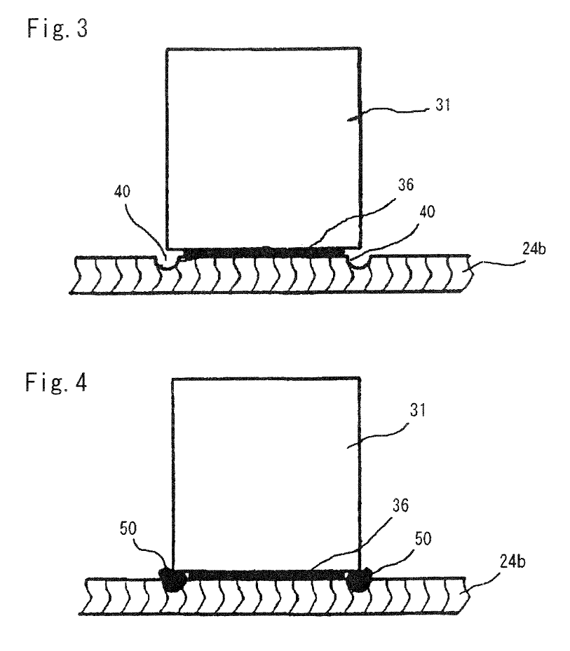

FIG. 2 is a perspective view illustrating the positional relation between the prism optical component 31 and the housing substrate (lower wall) 24b of the housing (pickup housing) 24. FIG. 3 and FIG. 4 are partially sectional views explaining how the prism optical component 31 is bonded to the housing substrate 24b of the housing 24.

As FIG. 2 shows, the prism optical component 31 is mounted at a prescribed position on a surface of the substrate 24b of the housing 24. The die-cast surfaces of the housing 24, including the substrate 24b, have been subjected to shot blasting and present smooth-surface page data. The prism optical component 31 is, for example, a prism. It is an injection molding made of resin. Its upper and lower surfaces have been made at the time of cutting the prism optical component 31 from the material and have sand-polished roughness. The lower surface is used as adhesion surface, which does not transmit light.

The substrate 24b of the housing 24, which holds the prism optical component 31, has hemispherical recesses 40 in those parts which correspond to the four corners of the lower surface of the prism optical component 31. The recesses 40 are provided to be filled with an adhesive. The recesses 40 need not be made in so large a number as four. It suffices to make at least two recesses, on a diagonal line.

It is desirable to change the size of recesses 40 in accordance with the size of the prism optical component 31. This is because the force holding, by adhesion, the prism optical component 31 varies with the size of the prism optical component 31. If the prism has a size of, for example, 4 mm×4 mm×4 mm, the recesses 40 made in the parts that correspond to the four corners of the prism should preferably be hemispheres having a diameter of, for example, 0.4 mm. Thus, it is desired that the recesses 40 be hemispherical and have a diameter about one tenth of the length of the outer size of the prism optical component 31. An adhesive 50 is applied into the hemispherical recesses 40, by using, for example, a syringe. The adhesion achieved with the adhesive 50 holds (or positions) the prism optical component 31 at an adjusted position in the process of bonding the prism optical component 31 to the substrate 24b of the housing 24. Therefore, the adhesive 50 is preferably an adhesive that can be fast dried and cured, such as UV-curable resin.

As indicated above, the prism optical component 31 is fixed to the substrate 24b, at the corners of its bottom, with the adhesive 50 applied into the recesses 40. Therefore, the adhesive 50 does not stick to those surfaces of the component 31, which transmit light. This adhesion structure prevents necessary light from being reflected by the adhesive 50 in the optical system provided in the optical disk drive.

In the optical disk drive having the prism optical component 31, the component and units should withstand vibration or impact of, for example, several hundred G, lasting for several milliseconds (msec), while the disk drive is being transported. Adhesive 36 serving this purpose should be applied uniformly to the lower surface of the prism optical component 31, forming as thin a layer as possible. This is because the components and units must remain at precise positions no matter how the environment changes after they are secured. The adhesive needs some time to be cured. Nonetheless, once cured, the adhesive can acquire a force large enough to hold the components and units against the impact. An adhesive that cures with time may be used instead, such as epoxy resin of two-liquid mixed type. Alternatively, a thermosetting resin, such as thermosetting epoxy resin, can be suitably used.

A method of bonding the prism optical component 31 to the substrate 24b of the housing 24 will be explained.

First, the prism optical component 31 is prepared. The housing 24, to which the component 31 will be fixed, is prepared, too.

Next, as shown in FIG. 2, the hemispherical recesses 40 are made in the substrate 24b of the housing 24, to which the prism optical component 31 will be fixed, at positions that correspond to the four corners of the prism optical component 31.

The surface of the prism optical component 31 and the surface of the substrate 24b of the housing 24, at which they are to be bonded together, are kept smooth and clean.

Both or one of these surfaces, preferably the lower surface of the prism optical component 31, is coated with a little amount of the adhesive 36 that cures with time or thermosetting adhesive 36 which forms a thin layer having uniform thickness, as is illustrated in FIG. 3. The prism optical component 31 is bonded to the substrate 24b, while being adjusted in position and angle.

Next, the adhesive 50 that can be fast dried and cured is applied, filling, as shown in FIG. 4, the recesses 40 made in the substrate 24b at positions corresponding to the four corners of the prism optical component 31. Thus applied, the adhesive 50 contacts the prism optical component 31 at the corners of the lower surface thereof. The adhesive 50 is cured in this condition. The prism optical component 31 is held at a precise position until the adhesive 36 that cures with time or the thermosetting adhesive 36 is completely cured with respect to the substrate 24b of the housing 24. The prism optical component 31 is thereby fixed to the substrate 24b.

If the adhesive 36 that cures with time is epoxy resin of two-liquid mixed type, it is left to stand until it is cured. If the adhesive 36 is thermosetting epoxy resin, it is heated in an oven or the like and thus cured.

As described above, in this embodiment, the prism optical component 31 can be secured to the substrate 24b of the housing by using the highly reliable adhesive 36, while positioned at high precision. Further, the laser beam can be prevented from being reflected by the adhesive 50 when it reaches the prism optical component 31.

The present invention is not limited to the embodiment described above. The components of the embodiment can be modified in various manners in reducing the invention to practice, without departing from the spirit or scope of the invention. Further, the components described in the above embodiment may be combined, if necessary, in various ways to make different inventions. For example, some of the components of any embodiment may be deleted. Moreover, the components of the different embodiments may be combined in any desired fashion.

What is claimed is:

1. An optical pickup comprising:
a substrate; and
a prism optical component fixed, with a first adhesive, at a predetermined position on the substrate,
wherein the substrate has a plurality of almost hemispherical recesses in a surface of the substrate, at positions corresponding to four corners of the prism optical component, and a second adhesive is applied into the recesses.

2. The optical pickup according to claim 1, wherein the first adhesive is of a type that is cured with time or a thermosetting type, and the second adhesive is one that is fast dried.

3. The optical pickup according to claim 1, wherein the adhesion accomplished by the second adhesive holds the prism optical component at the predetermined position on the substrate until the first adhesive is cured.

4. The optical pickup according to claim 1, wherein the recesses are almost hemispherical and have a diameter that is about one tenth of an outer size of the prism optical component.

5. The optical pickup according to claim 1, wherein the optical component is a prism.

6. An optical disk drive comprising an optical pickup of the type described in claim 1.

7. A method of bonding an optical component to a substrate of an optical pickup, comprising the steps of:
making a plurality of almost hemispherical recesses in the substrate, at positions corresponding to four corners of a prism optical component to be bonded and secured to the substrate;
applying an adhesive to a back of the prism optical component and mounting the prism optical component on the substrate; and
positioning the prism optical component at a prescribed position on the substrate, applying an adhesive into the recesses and adhering the prism optical component to the substrate.

8. The method according to claim 7, wherein the adhesive applied to the back of the prism optical component is of a type that is cured with time or a thermosetting type, and the adhesive applied into the recesses is one that is fast dried.
